(19) United States
(12) Patent Application Publication
(10) Pub. No.: US 2015/0153487 A1
(43) Pub. Date: Jun. 4, 2015

(54) WAVELENGTH-CONVERTING DEVICE

(71) Applicant: DELTA ELECTRONICS, INC., Taoyuan Hsien (TW)

(72) Inventors: Chien-Hao Hua, Taoyuan Hsien (TW); Keh-Su Chang, Taoyuan Hsien (TW); Yen-I Chou, Taoyuan Hsien (TW); Chi Chen, Taoyuan Hsien (TW); Jau-Shiu Chen, Taoyuan Hsien (TW); Meng-Han Liu, Taoyuan Hsien (TW)

(21) Appl. No.: 14/489,945

(22) Filed: Sep. 18, 2014

Related U.S. Application Data
(60) Provisional application No. 61/910,177, filed on Nov. 29, 2013.

(30) Foreign Application Priority Data
May 30, 2014 (TW) 103118987

(51) Int. Cl. G02B 5/08; G02B 26/00

(52) U.S. Cl. CPC G02B 5/0875; G02B 26/008

(57) ABSTRACT

A wavelength-converting device includes a substrate and a reflective layer. The reflective layer is disposed on the substrate, among which when an operating temperature of the reflective layer is higher than or equal to 130° C., the reflective layer is formed of a first metallic material, and when the operating temperature of the reflective layer is lower than 130° C., the reflective layer is formed of a second metallic material. The reflectivity of the second metallic material is higher than the reflectivity of the first metallic material at room temperature. By forming the reflective layer of the first metallic material and the second metallic material at different operating temperatures, respectively, the decay of the reflectivity is effectively avoided, the reflectivity is optimized, and the converting efficiency of the wavelength-converting device is enhanced.

### CROSS-REFERENCE TO RELATED APPLICATION

This application claims the benefit of U.S. Provisional Application No. 61/910,177 filed on Nov. 29, 2013, and entitled “PHOSPHOR WHEEL STRUCTURE FOR HIGH LUMEN PROJECTOR”, the entirety of which is hereby incorporated by reference.

### FIELD OF THE INVENTION

The present invention relates to a wavelength-converting device, and more particularly to a wavelength-converting device applied for converting optical wavelength of a projector.

### BACKGROUND OF THE INVENTION

In recent years, solid-state light-emitting elements and wavelength-converting devices (e.g. phosphor wheels) are mostly utilized as illumination systems for breaking the limitation of the energy efficiency of conventional lamps of large venue projectors. The three primary colors of light source are emitted by solid-state light-emitting elements or transformed by the wavelength-converting devices.

High-lumen performance becomes the mainstream of the development of large venue projectors for meeting the requirement and demand of users. In a high-lumen projector, highly power solid-state light-emitting element, such like a laser element, is utilized as an exciting light source of the phosphor powder or the phosphor agent, so that a high operating temperature is induced during the transformation of the wavelength-converting device. Since Ag is commonly coated as the reflective layer of a glossy aluminum substrate of a wavelength-converting device of prior art, the wavelength-converting device is unstable at high temperature, the reflectivity of the Ag reflective layer will decay, and the lifetime and the reliability of the wavelength-converting device are decreased due to the characteristics of Ag.

Please refer to FIG. 1, which illustrates the result of an aging test. FIG. 1 schematically illustrates the working time-dependent reflectivity diagram of a glossy aluminum substrate with an Ag reflective layer at 180° C. When Ag is utilized as a reflection coating of a wavelength-converting device, the reflectivity of the reflection coating will decay after baking for 1250 hours at 180° C., the ratio of the reflectivity of the reflection coating after baking for 2000 hours to the original reflectivity of the reflection coating itself is only 80%, and after baking for 3000 hours, the ratio of the reflectivity of the reflection coating to the original reflectivity of the reflection coating itself is even less than 40%. The converting efficiency of the wavelength-converting device is significantly decreased.

Please refer to FIG. 2 and FIG. 3. FIG. 2 schematically illustrates the high magnification microscope image of the Ag reflection coating after baking 0 hour at 180° C. FIG. 3 schematically illustrates the high magnification microscope image of the Ag reflection coating after baking 1250 hours at 180° C. As shown in FIG. 2, the reflectivity of Ag reflection coating is about 97% to 98%, which is extremely high, after working 0 hour (i.e. the baking has not started). Consequently, the light emitted by the lamp of the microscope is almost total reflected, which is schematically illustrated as a plain image as shown in FIG. 2. After baking 1250 hours at 180° C. environment, due to the nature of Ag of high mobility and high ductility, a portion of Ag atoms aggregates or even migrates into the underlying porous vacancies, caused through an anodic oxidation treatment on the surface of the glossy aluminum substrate. Another portion of Ag atoms are reacted with the oxygen molecules, so that the silver oxide molecules, which are showed as black dots in the high magnification microscope image, are formed through the oxidation reaction. As a result, the reflectivity of the reflection coating is decreased.

Please refer to FIG. 4. FIG. 4 schematically illustrates the high magnification microscope image of the Ag reflection coating after baking 155 hours at 250° C. As shown in FIG. 4, when the baking temperature or the operating temperature is increased, for example from 180° C. to 250° C., the above-mentioned reactions of Ag atoms are intensified. The Ag reflection coating are showed as lots of black dots or black blocks, and the gloss and the reflectivity of the reflection coating are significantly decreased after only about 155 hours. Under this circumstance, the converting efficiency of the wavelength-converting device is poor, and the luminance, brightness and image quality of the projector are decreased.

Therefore, there is a need of providing an improved wavelength-converting device in order to overcome the above drawbacks.

### SUMMARY OF THE INVENTION

The present invention provides a wavelength-converting device in order to overcome the above-mentioned drawbacks encountered by the prior arts.

The present invention provides a wavelength-converting device. By forming the reflective layer of the first metallic material and the second metallic material for different operating temperature regimes, respectively, the decay of the reflectivity is effectively avoided, the reflectivity is optimized, and the converting efficiency of the wavelength-converting device is improved.

The present invention provides a wavelength-converting device. Since the material of the reflective layer is adaptively selected at different operating temperatures, the ratio of the reflectivity of the reflective layer after working 3000 hours to the original reflectivity of the reflective layer is still higher than 95 percent.

In accordance with an aspect of the present invention, there is provided a wavelength-converting device. The wavelength-converting device includes a substrate and a reflective layer. The reflective layer is disposed on the substrate. When an operating temperature of the reflective layer is greater than or equal to 130° C., the reflective layer is formed of a first metallic material, and when the operating temperature of the reflective layer is less than 130° C., the reflective layer is formed of a second metallic material, among which the reflectivity of the second metallic material is greater than the reflectivity of the first metallic material at room temperature.

In accordance with another aspect of the present invention, there is provided a wavelength-converting device. The wavelength-converting device includes a substrate, a reflective layer and a wavelength-converting layer. The reflective layer is disposed on the substrate. The wavelength-converting layer is formed on the reflective layer. When an operating temperature of the wavelength-converting layer and the reflective layer is greater than or equal to 130° C., the reflective layer is formed of aluminum or aluminum alloy, and when the operating temperature of the wavelength-converting layer and the reflective layer is less than 130° C., the reflective layer is formed of silver or silver alloy.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the working time-relative reflectivity diagram of a glossy aluminum substrate with an Ag reflective layer at 180° C.;

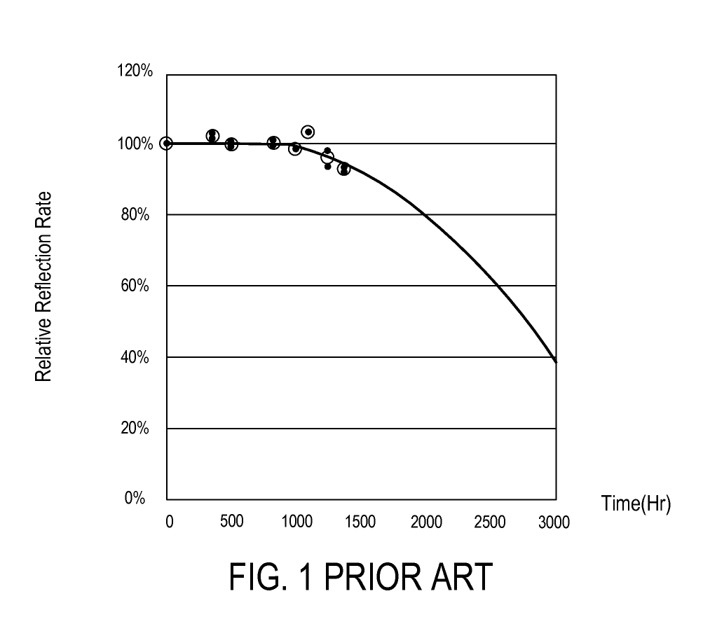

FIG. 2 schematically illustrates the high magnification microscope image of the Ag reflection coating after working 0 hour at 180° C.;

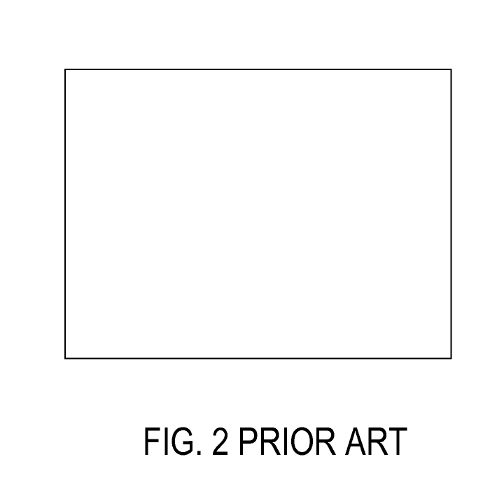

FIG. 3 schematically illustrates the high magnification microscope image of the Ag reflection coating after working 1250 hours at 180° C.;

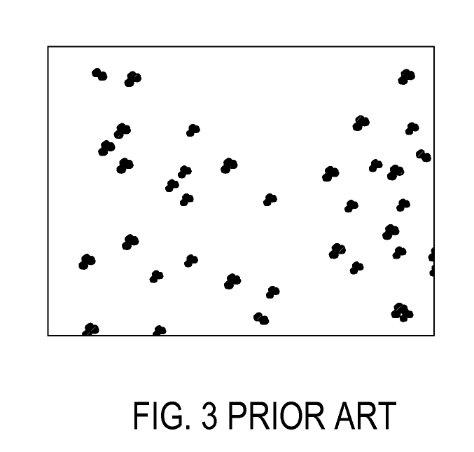

FIG. 4 schematically illustrates the high magnification microscope image of the Ag reflection coating after working 155 hours at 250° C.;

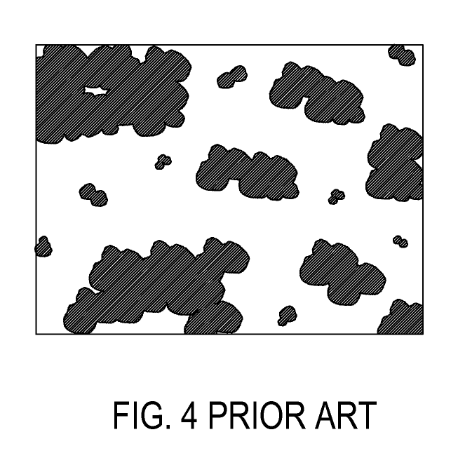

FIG. 5 schematically illustrates the structure of a wavelength-converting device according to an embodiment of the present invention;

FIG. 6A schematically illustrates the front view of the wavelength-converting device of FIG. 5;

FIG. 6B schematically illustrates the front view of a wavelength-converting device according to another embodiment of the present invention;

FIG. 7 schematically illustrates the working time-relative reflectivity diagram of a glossy aluminum substrate with an aluminum reflective layer at 180° C.;

FIG. 8 schematically illustrates the high magnification microscope image of the aluminum reflective layer after working 0 hour at 180° C.; and

FIG. 9 schematically illustrates the high magnification microscope image of the aluminum reflective layer after working 1250 hours at 180° C.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

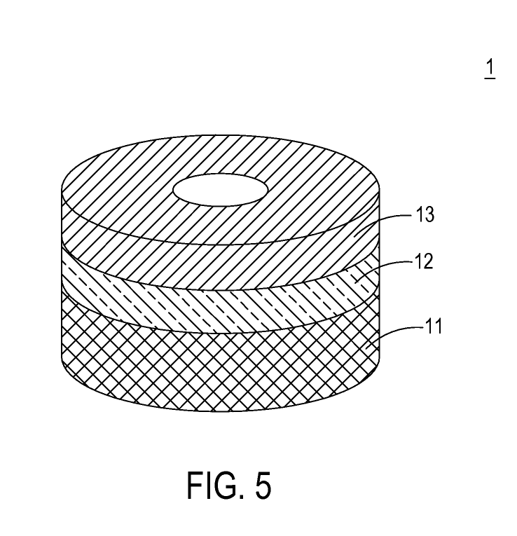

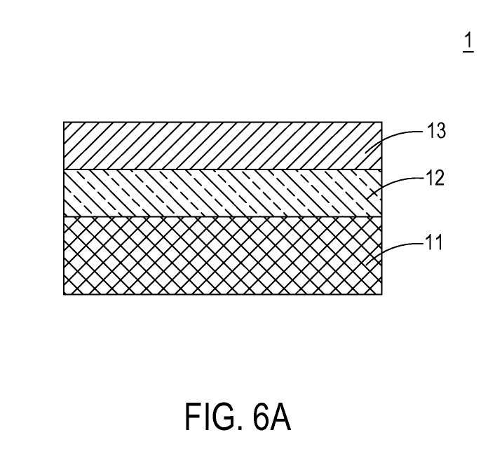

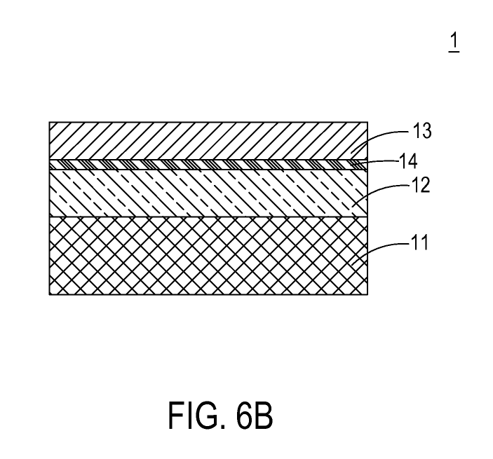

FIG. 5 schematically illustrates the structure of a wavelength-converting device according to an embodiment of the present invention. FIG. 6A schematically illustrates the front view of the wavelength-converting device of FIG. 5. As shown in FIG. 5 and FIG. 6A, a wavelength-converting device 1 according to an embodiment of the present invention is not limited to a phosphor wheel. The wavelength-converting device 1 includes a substrate 11 and a reflective layer 12. The reflective layer 12 is disposed on the substrate 11. When an operating temperature of the reflective layer 12 is greater than or equal to 130° C., the reflective layer 12 is formed of a first metallic material. A metallic material has relatively high reflectivity after working 1250 hours or 3000 hours at the operating temperature greater than or equal to 130° C., which is not limited to a metal or an alloy, is selected so as to be the first metallic material.

Similarly, based on the consideration of material properties, a second metallic material having the reflectivity, which is greater than the reflectivity of the first metallic material at room temperature, must exists. In order to avoid the decay of the reflectivity after working specified hours, when the operating temperature of the reflective layer 12 is less than 130° C., the reflective layer 12 is preferably formed of a second metallic material, but not limited thereto. In other words, by forming the reflective layer 12 of the first metallic material and the second metallic material at different operating temperatures, respectively, the decay of the reflectivity is effectively avoided, the reflectivity is optimized, and the converting efficiency of the wavelength-converting device 1 is enhanced.

In some embodiments, the substrate 11 is a glossy aluminum substrate prior treated through an anodic oxidation treatment (electro-polishing), and sequentially the reflective layer 12 is formed on the substrate 11 through a vacuum coating process. Meanwhile, the first metallic material is aluminum or an aluminum alloy, and the second metallic material is argentum (i.e. Silver or Ag) or an argentum alloy. The reflectivity of the argentum or the argentum alloy is higher than the reflectivity of the aluminum or the aluminum alloy at room temperature, and the decay of the reflectivity of the argentum or the argentum alloy after working specified hours at the operating temperature less than 130° C. will not occur. Under this circumstance, even though the argentum or the argentum alloy has the drawbacks encountered by the prior arts, the argentum or the argentum alloy is still a preferred selection of material for utilizing at the operation temperature less than 130° C.

In some embodiments, the wavelength-converting device 1 of the present invention further includes at least one oxide dielectric layer. Please refer to FIG. 6B. FIG. 6B schematically illustrates the front view of a wavelength-converting device according to another embodiment of the present invention. As shown in FIG. 6B, at least one oxide dielectric layer 14 can be plated on the reflective layer 12, which is formed of the first metallic material or the second metallic material, for protecting or modulating the reflection spectrum of the first metallic material or the second metallic material. In another embodiments, the oxide dielectric layer 14 is deposited on the reflective layer 12 for protecting or modulating the reflection spectrum of the reflective layer, but not limited thereto.

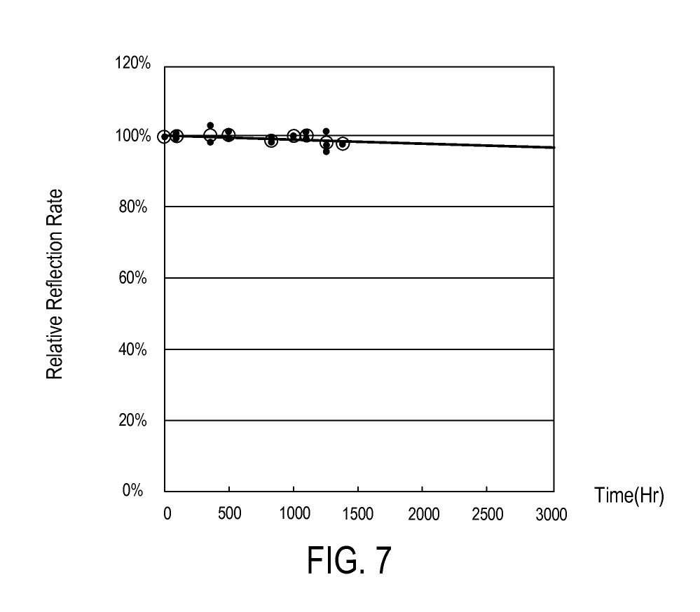

FIG. 7 schematically illustrates the working time-relative reflectivity diagram of a glossy aluminum substrate with an aluminum reflective layer at 180° C. As shown in FIG. 5 and FIG. 7, when the reflective layer 12 of the wavelength-converting device 1 is formed of an aluminum coating, the ratio of the reflectivity of the reflective layer 12 after working 1250 hours at 180° C. to the original reflectivity of the reflective layer 12 is still greater than 98 percent, and the ratio of the reflectivity of the reflective layer 12 after working 3000 hours at 180° C. to the original reflectivity of the reflective layer 12 is still greater than 95 percent. That is, since the material of the reflective layer 12 is adaptively selected at different operating temperatures, the ratio of the reflectivity of the reflective layer 12 after working 3000 hours at high operating temperature to the original reflectivity of the reflective layer 12 is still greater than 95 percent.

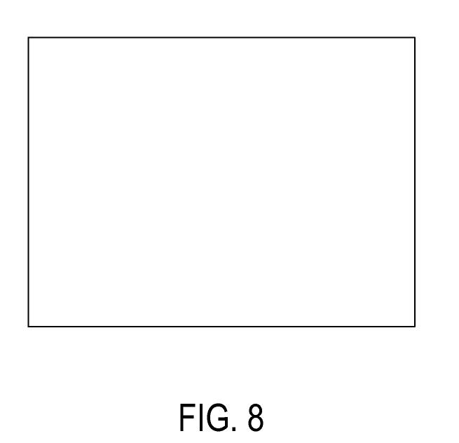

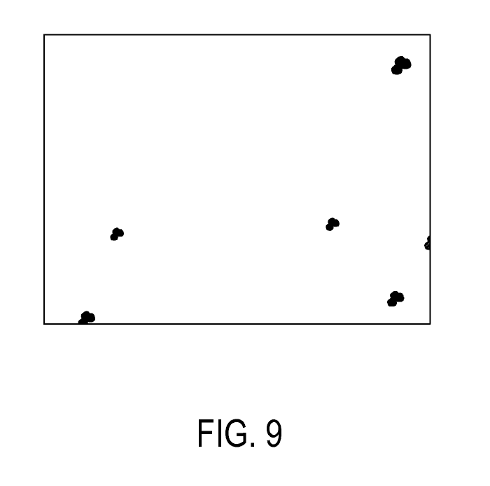

FIG. 8 schematically illustrates the high magnification microscope image of the reflective layer formed of aluminum after working 0 hour at 180° C. FIG. 9 schematically illustrates the high magnification microscope image of the reflective layer formed of aluminum after working 1250 hours at 180° C. As shown in FIG. 5, FIG. 8 and FIG. 9, the reflectivity of the reflective layer 12 formed of an aluminum coating is extremely high after working 0 hour (i.e. the working has not started), so that the light emitted by the lamp of the microscope is almost total reflected. After working 1250 hours at 180° C., few aluminum atoms of the reflective layer 12 are migrated or oxidized. Consequently, few black dots (i.e. aluminum oxide molecules) are observed in the high magnification microscope image. It should be noted that the influence of the migration and oxidation of aluminum on the change of the reflectivity is less than 2 percent, so that the decay of the reflectivity of the reflective layer 12 is effectively avoided, and the reflectivity is optimized.

Please refer to FIG. 5 and FIG. 6 again. The thickness of the substrate 11 of the wavelength-converting device 1 of the present invention is preferably 0.4 to 4.0 mm, and the diameters of the reflective layer 12 and the substrate 11 are preferably 50 to 150 mm, respectively, but not limited thereto. Additionally, the wavelength-converting device 1 of the present invention further includes a wavelength-converting layer 13. The wavelength-converting layer 13, which is for example a phosphor layer, is formed on the reflective layer 12 for transforming an incident light, such that the optical wavelength of the incident light is converted.

From the above descriptions, the present invention provides a wavelength-converting device. By forming the reflective layer of the first metallic material and the second metallic material at different operating temperatures, respectively, the decay of the reflectivity is effectively avoided, the reflectivity is optimized, and the converting efficiency of the wavelength-converting device is enhanced. Meanwhile, since the material of the reflective layer is adaptively selected at different operating temperatures, the ratio of the reflectivity of the reflective layer after working 3000 hours to the original reflectivity of the reflective layer is still greater than 95 percent.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wavelength-converting device, comprising
a substrate; and
a reflective layer disposed on the substrate, wherein when an operating temperature of the reflective layer is greater than or equal to 130° C., the reflective layer is formed of a first metallic material, and when the operating temperature of the reflective layer is less than 130° C., the reflective layer is formed of a second metallic material, and wherein the reflectivity of the second metallic material is higher than the reflectivity of the first metallic material at room temperature.

2. The wavelength-converting device according to claim 1, wherein the substrate is a glossy aluminum substrate prior treated through an anodic oxidation treatment, and the reflective layer is formed on the substrate.

3. The wavelength-converting device according to claim 1, wherein the first metallic material is aluminum or an aluminum alloy.

4. The wavelength-converting device according to claim 1, wherein the second metallic material is argentum or an argentum alloy.

5. The wavelength-converting device according to claim 1 further comprising at least one oxide dielectric layer, wherein the oxide dielectric layer is deposited on the first metallic material for protecting or modulating the reflection spectrum of the first metallic material.

6. The wavelength-converting device according to claim 1 further comprising at least one oxide dielectric layer, wherein the oxide dielectric layer is deposited on the second metallic material for protecting or modulating the reflection spectrum of the second metallic material.

7. The wavelength-converting device according to claim 1, wherein the thickness of the substrate is 0.4 to 4.0 mm.

8. The wavelength-converting device according to claim 1, wherein the diameters of the reflective layer and the substrate are 50 to 150 mm.

9. The wavelength-converting device according to claim 1, wherein the ratio of the reflectivity of the reflective layer after working 1250 hours to the original reflectivity of the reflective layer is greater than 98 percent.

10. The wavelength-converting device according to claim 1, wherein the ratio of the reflectivity of the reflective layer after working 3000 hours to the original reflectivity of the reflective layer is greater than 95 percent.

11. The wavelength-converting device according to claim 1 further comprising a wavelength-converting layer formed on the reflective layer.

12. A wavelength-converting device, comprising:
a substrate;
a reflective layer disposed on the substrate; and
a wavelength-converting layer formed on the reflective layer, wherein when an operating temperature of the wavelength-converting layer and the reflective layer is greater than or equal to 130° C., the reflective layer is formed of aluminum or aluminum alloy, and when the operating temperature of the wavelength-converting layer and the reflective layer is less than 130° C., the reflective layer is formed of argentum or argentum alloy.

13. The wavelength-converting device according to claim 12, wherein the substrate is a glossy aluminum substrate prior treated through an anodic oxidation treatment, and the reflective layer is formed on the substrate.

14. The wavelength-converting device according to claim 12 further comprising at least one oxide dielectric layer, wherein the oxide dielectric layer is deposited on the reflective layer for protecting or modulating the reflection spectrum of the reflective layer.

15. The wavelength-converting device according to claim 12 further comprising at least one oxide dielectric layer, wherein the oxide dielectric layer is integrated with the reflective layer for protecting or modulating the reflection spectrum of the reflective layer.

16. The wavelength-converting device according to claim 12, wherein the thickness of the substrate is 0.4 to 4.0 mm.

17. The wavelength-converting device according to claim 12, wherein the diameters of the reflective layer and the substrate are 50 to 150 mm.

18. The wavelength-converting device according to claim 12, wherein the ratio of the reflectivity of the reflective layer after working 1250 hours to the original reflectivity of the reflective layer is greater than 98 percent.

19. The wavelength-converting device according to claim 12, wherein the ratio of the reflectivity of the reflective layer after working 3000 hours to the original reflectivity of the reflective layer is greater than 95 percent.

20. The wavelength-converting device according to claim 12, wherein the wavelength-converting layer is a phosphor layer.
